(19) United States
(12) Patent Application Publication
(10) Pub. No.: US 2004/0160545 A1
(43) Pub. Date: Aug. 19, 2004

(54) Screen structure capable of embedding liquid crystal display therein

(76) Inventor: Chun-Chieh Pai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/365,400

(22) Filed: Feb. 13, 2003

(51) Int. Cl. G02F 1/1333

(52) U.S. Cl. 349/58

(57) ABSTRACT

A screen structure capable of embedding a liquid crystal display therein is proposed, wherein a placement hole for disposing a liquid crystal display is provided in a screen partition. Fixing holes for fixing the liquid crystal display are disposed in a movable baffle. Moreover, adjustment sides are disposed at. edges of two projective faces of the movable baffle, respectively. A user can adjust the liquid crystal display to an angular position more suitable for use through the adjustment sides.

### FIELD OF THE INVENTION

The present invention relates to a screen structure capable of embedding a liquid crystal display therein and, more particularly, to a screen structure having a space for disposing a liquid crystal display.

### BACKGROUND OF THE INVENTION

Conventional screens for personal desks, computer desks, or other types of desks are assembled by screen partitions enclosing around the desktops thereof. For convenient use, liquid crystal displays are usually placed on the desktops, hence greatly decreasing usable space on the desktops. Besides, a too crowded working space will bring about discomfort to a user, and will indirectly results in rise of psychological pressure, hence reducing the working efficiency and causing fatigue in physiology and psychology.

As shown in FIG. 1, a conventional screen structure comprises a screen module 60 and a screen partition 61. The screen module 60 is a base installed on the ground. The screen partition 61 is a rectangular plate, and is disposed at the side of the screen module 60.

The screen partition 61 of the conventional screen structure is a hermetically sealed rectangular plate, and has no gap designed for disposing a liquid crystal display 62. Therefore, a user usually has to place the liquid crystal display 62 near a side of a desktop 63 so as to let the desktop be disorderly and occupy much space of the desktop 63, hence resulting in much inconvenience in work and also lowering the working efficiency.

Accordingly, the above conventional screen structure has inconvenience and drawbacks in practical use. The present invention aims to resolve the problems in the prior art.

### SUMMARY OF THE INVENTION

The primary object of the present invention is to provide a screen structure capable of embedding a liquid crystal display therein, wherein a placement hole is provided on a screen partition for disposing a liquid crystal display. The liquid crystal display will not occupy the usable space of a desktop. A wider and more comfortable personal working space can thus be provided for a common user.

Another object of the present invention is to provide a screen structure capable of embedding a liquid crystal display therein so as to solve the problems in the prior art such as increase of pressure, fatigue in physiology and psychology, discomfort in work, and bad working efficiency.

To achieve the above objects, the present invention provides a screen structure capable of embedding a liquid crystal display therein. The screen structure comprises a screen module, a screen partition, and a movable baffle. The screen module has a partition fixing hole, and is installed on the ground. The screen partition has a placement hole and a joint sheet. The screen partition is fastened in the partition fixing hole. The placement hole is disposed in the screen partition. The joint sheet is joined on the screen partition. Moreover, the movable baffle has adjustment sides, and is locked onto the joint sheet. The adjustment sides are projectively disposed on the movable baffle. The screen structure capable of embedding a liquid crystal display therein is thus formed.

The various objects and advantages of the present invention will be more readily understood from the following detailed description when read in conjunction with the appended drawing, in which:

### BRIEF DESCRIPTION OF THE DRAWINGS:

FIG. 1 is a diagram showing a use state of a conventional screen structure;

FIG. 2 is an exploded perspective view of the present invention;

FIG. 3 is a perspective view of the present invention;

FIG. 4 is a partly enlarged diagram showing a use state of the present invention;

FIG. 5 is a partly enlarged diagram showing another use state of the present invention;

FIG. 6 is a partly enlarged diagram showing yet another use state of the present invention;

FIG. 7 shows a first use state according to another embodiment of the present invention; and

FIG. 8 shows a second use state according to another embodiment of the present invention.

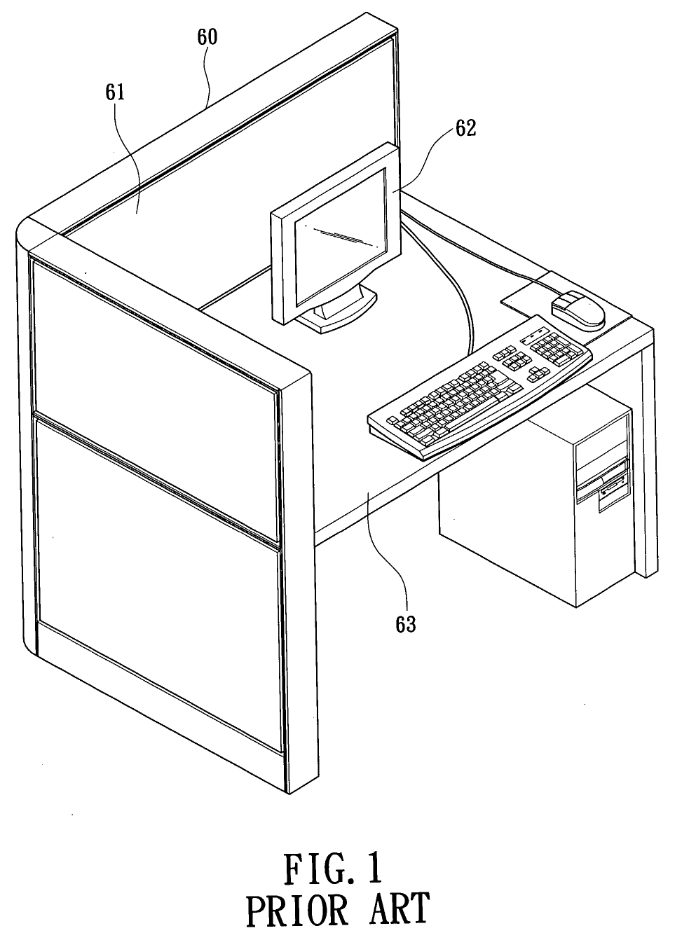

### DETAILED DESCRIPTION OF THE PREFERRED EMBODIMENTS

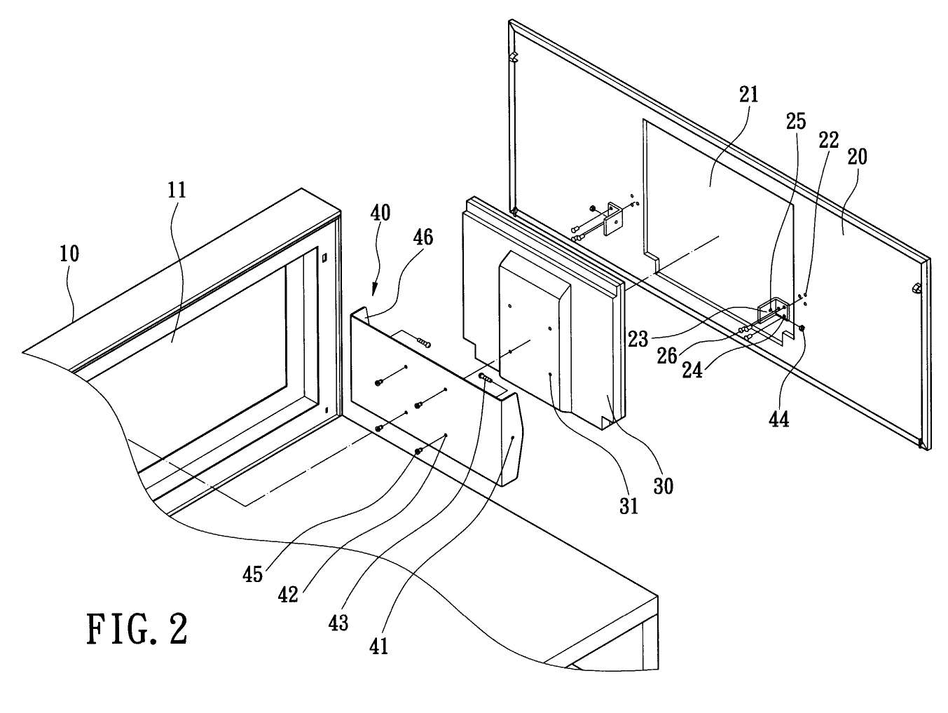

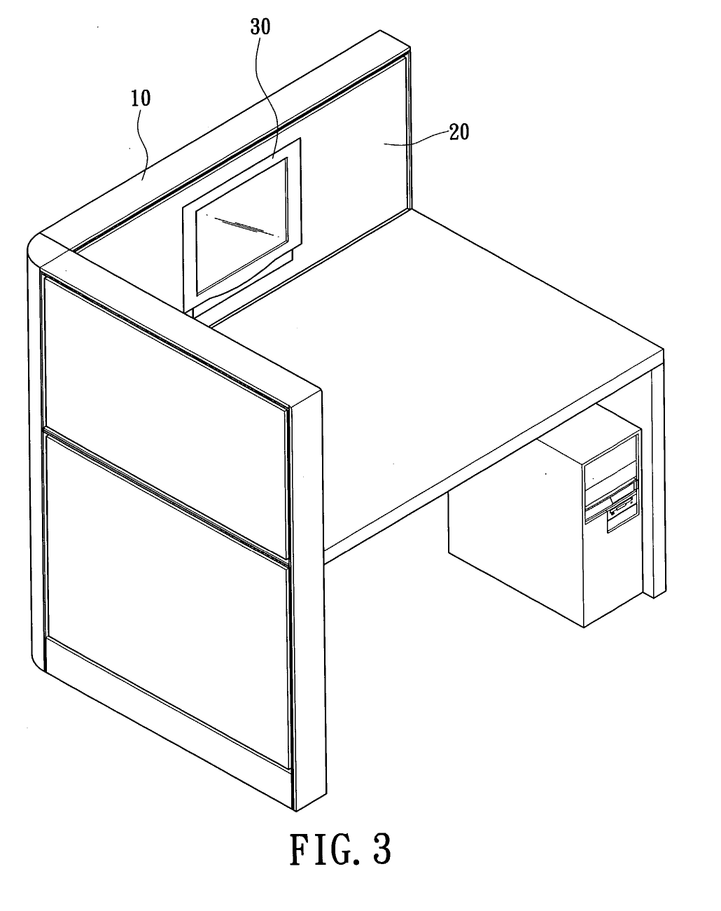

As shown in FIGS. 2 and 3, the present invention provides a screen structure capable of embedding a liquid crystal display 30 therein. The screen structure comprises a screen module 10, a screen partition 20, the liquid crystal display 30, and a movable baffle 40.

The screen module 10 is a base installed on the ground. One face of the screen module 10 has a rectangular partition fixing hole 11. The partition fixing hole 11 is disposed on the screen module 10.

The screen partition 20 has a placement hole 21, first rivet holes 22, a joint sheet 23, second rivet holes 24, a first screen hole 25, and rivets 26. The screen partition 20 is a rectangular plate, and is fastened in the partition fixing hole 11 of the screen module 10. The placement hole 21 is rectangular, and is disposed at the center of the screen partition 20. The first rivet holes 22 are respectively disposed at two sides of the placement hole 21. The joint sheet 23 us an L-shaped sheet. One face of the joint sheet 23 is joined on the screen partition 20, and the other face thereof is joined on the movable baffle 40. The second rivet holes 24 and the first screw hole 25 are disposed on two perpendicular planes of the joint sheet 23, respectively. The rivets 26 are inserted into the second rivet holes 24 and the first rivet holes 22 to connect the joint sheet 23 on the screen partition 20.

The liquid crystal display 30 is rectangular. One face of the liquid crystal display 30 has second fixing holes 31. The liquid crystal display 30 is disposed on the placement hole 21.

The movable baffle 40 has second screw holes 41, first fixing holes 42, screws 43, screw nuts 44, fixing nails 45, and adjustment sides 46. The movable baffle 40 is a concave plate, and is locked on the joint sheet 23 of the screen partition 20. The second screw holes 41 are respectively disposed on two projective faces of the movable baffle 40. The adjustment sides 46 are projectively disposed at edges of the two projective faces of the movable baffle 40. The adjustment sides 46 are of a curved shape connected at the edges of the two projective faces of the movable baffle 40. The first fixing holes 42 are concavely disposed at the middle positions of the other face of the movable baffle 40. The screws 43 are inserted into the second screw holes 41 and the first screw holes 25, and the screw nuts 44 are then slipped onto the screws 43 for fixation, hence fixing the movable baffle 40 onto the screen partition 20. The fixing nails 45 are inserted into the first fixing holes 42 and the second fixing holes 31 to make sure the liquid crystal display 30 will not fall off. The screen structure capable of embedding a liquid crystal display therein of the present invention is thus formed.

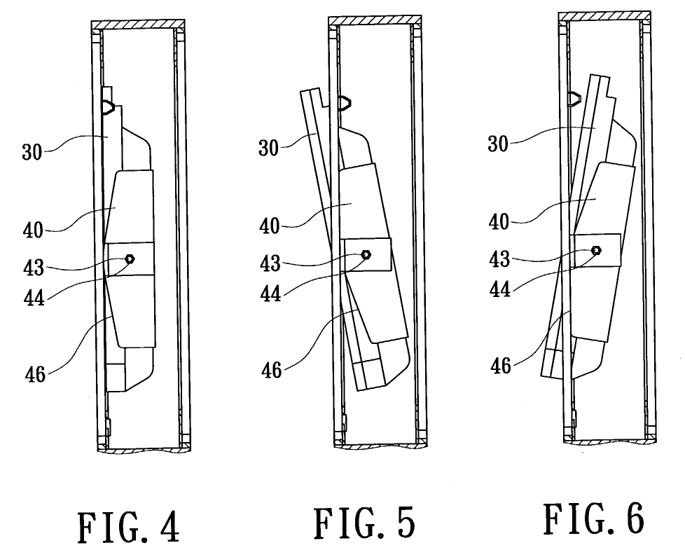

As shown in FIGS. 4 to 6, the liquid crystal display 30 makes use of the locking function of the screws 43 and the screw nuts 44 to be fixed on the movable baffle 40. However, the locking state of the screws 43 and the screw nuts 44 is not deadlocked. Moreover, because the adjustment sides 46 of the movable baffle 40 are of a curved shape connected at the edges of the two projective faces of the movable baffle 40, they will not collide with obstacles to affect rotation. Therefore, the locked positions of the screws 43 and the screw nuts 44 can let both the movable baffle 40 and the liquid crystal have rotatable function so that a user can adjust the liquid crystal display 30 to a visual angle suitable for viewing.

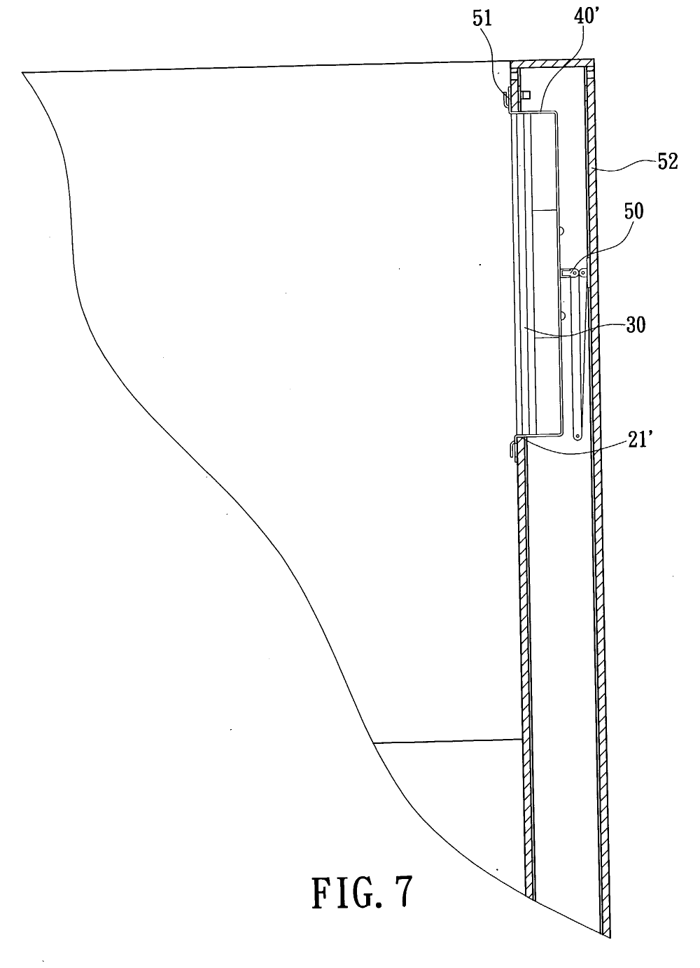

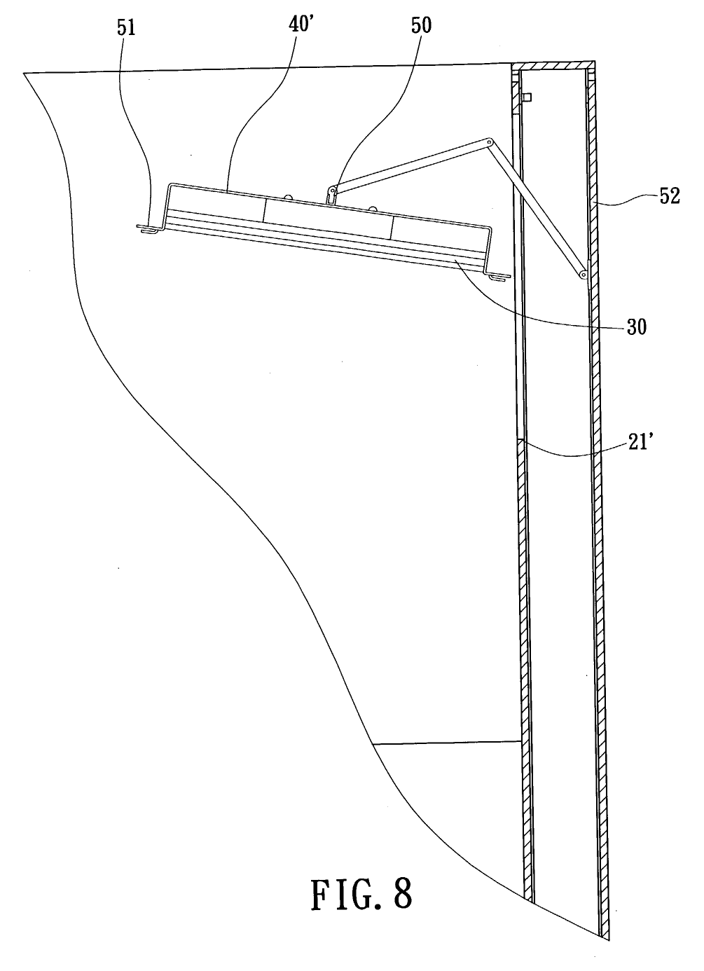

In consideration that there is no screen structure in front of desks in some offices. The screens are instead disposed at the side of the desks. Therefore, as shown in FIGS. 7 and .8, a universal foldable device 5 is connected at a face of a movable baffle 40′. Positioning locks 51 are projectively extended from edges of two projective faces of the movable baffle 40′, respectively. One end of the universal foldable device is connected at a face of the movable baffle 40′, and the other end thereof is fixed at a face of a screen module 52. The front of the screen module 52 is not shielded by a screen partition. The universal foldable device 50 can let a user adjust the liquid crystal display 30 to a position more suitable for his line of vision. The positioning locks 51 are used to prevent the liquid crystal display 30 from sinking into a placement hole 21′ when folded back.

To sum up, in the screen structure capable of embedding a liquid crystal display therein of the present invention, a placement hole is designed on a screen partition for disposing a liquid crystal display. The problem of crowded usable space on a desktop when the liquid crystal display is placed on the desktop can thus be overcome. Moreover, because adjustment sides are designed at edges of two projective faces of a movable baffle, a user can adjust the liquid crystal display to a visual angle suitable for viewing. In other words, the screen structure capable of embedding a liquid crystal display therein of the present invention also conforms to ergonomics, hence letting a user have a more comfortable use environment.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A screen structure capable of embedding a liquid crystal display therein, comprising:
a screen module having a partition fixing hole, said screen module being installed on the ground, said partition fixing hole being disposed on said screen module;
a screen partition having a placement hole and a joint sheet, said screen partition being fastened in said partition fixing hole, said placement hole being disposed in said screen partition, said joint sheet being joined on said screen partition; and
a movable baffle having adjustment sides, said movable baffle being locked onto said joint sheet, said adjustment sides being projectively disposed on said movable baffle.

2. The screen structure capable of embedding a liquid crystal display therein as claimed in claim 1, wherein positioning locks are projectively extended from edges of two projective faces of said movable baffle, respectively.

3. The screen structure capable of embedding a liquid crystal display therein as claimed in claim 1, wherein a universal foldable device is connected at a face of said movable baffle, one end of said universal foldable device is connected at said movable baffle, and the other end thereof is fixed at a face of said screen module.

4. The screen structure capable of embedding a liquid crystal display therein as claimed in claim 1, wherein said adjustment sides are of a curved shape connected at edges of two projective faces of said movable baffle.

5. The screen structure capable of embedding a liquid crystal display therein as claimed in claim 1, wherein said joint sheet is an L-shaped sheet, one face of said joint sheet is connected and fixed at one face of said screen partition, and the other face thereof is connected at said movable baffle.
